(19) United States
(12) Patent Application Publication
(10) Pub. No.: US 2023/0171160 A1
(43) Pub. Date: Jun. 1, 2023

(54) SYSTEMS AND METHODS FOR ADAPTIVE BANDWIDTH GRANT SCHEDULING

(71) Applicant: ARRIS Enterprises LLC, Suwanee, GA (US)

(72) Inventors: Tushar MATHUR, Caledon (CA); Gregory J. GOHMAN, Beaverton, OR (US); Parasuram RANGANATHAN, Brampton (CA)

(73) Assignee: ARRIS Enterprises LLC, Suwanee, GA (US)

(21) Appl. No.: 18/071,334

(22) Filed: Nov. 29, 2022

Related U.S. Application Data
(60) Provisional application No. 63/283,823, filed on Nov. 29, 2021.

(51) Int. Cl. H04L 41/0896; H04L 47/83; H04L 12/28

(52) U.S. Cl. CPC H04L 41/0896; H04L 12/2801; H04L 47/83

(57) ABSTRACT

Systems and methods that adaptively grant amounts of bandwidth to a remote device for upstream transmissions. The systems and methods may adaptively grant a first amount of bandwidth during a first interval, and vary the amount of bandwidth proactively granted over subsequent intervals using a metric of usage of the proactive bandwidth granted.

### CROSS REFERENCE TO RELATED APPLICATIONS

The present application claims priority to U.S. Provisional Application. No. 63/283,823 filed Nov. 29, 2021, the contents of which are incorporated herein by reference in their entirety.

### BACKGROUND

The subject matter of this application generally relates to implementing low-latency traffic in a Data over Cable Service Interface Specification (DOCSIS) environment.

Cable Television (CATV) services have historically provided content to large groups of subscribers from a central delivery unit, called a “head end,” which distributes channels of content to its subscribers from this central unit through a branch network comprising a multitude of intermediate nodes. Historically, the head end would receive a plurality of independent programming content, multiplex that content together while simultaneously modulating it according to a Quadrature Amplitude Modulation (QAM) scheme that maps the content to individual frequencies or “channels” to which a receiver may tune so as to demodulate and display desired content.

Modem CATV service networks, however, not only provide media content such as television channels and music channels to a customer, but also provide a host of digital communication services such as Internet Service, Video-on-Demand, telephone service such as VoIP, and so forth. These digital communication services, in turn, require not only communication in a downstream direction from the head end, through the intermediate nodes and to a subscriber, but also require communication in an upstream direction from a subscriber, and to the content provider through the branch network.

To this end, these CATV head ends include a separate Cable Modem Termination System (CMTS), used to provide high speed data services, such as video, cable Internet, Voice over Internet Protocol, etc. to cable subscribers. Typically, a CMTS will include both Ethernet interfaces (or other more traditional high-speed data interfaces) as well as RF interfaces so that traffic coming from the Internet can be routed (or bridged) through the Ethernet interface, through the CMTS, and then onto the optical RF interfaces that are connected to the cable company’s hybrid fiber coax (HFC) system. Downstream traffic is delivered from the CMTS to a cable modem in a subscriber’s home, while upstream traffic is delivered from a cable modem in a subscriber’s home back to the CMTS. Many modern CATV systems have combined the functionality of the CMTS with the video delivery system (EdgeQAM) in a single platform called the Converged Cable Access Platform (CCAP). The foregoing architectures are typically referred to as centralized access architectures (CAA) because all of the physical and control layer processing is done at a central location, e.g., a head end.

Recently, distributed access architectures (DAA) have been implemented that distribute the physical layer processing, and sometimes the MAC layer processing deep into the network. Such system include Remote PHY (or R-PHY) architectures, which relocate the physical layer (PHY) of a traditional CCAP by pushing it to the network’s fiber nodes. Thus, while the core in the CCAP performs the higher layer processing, the R-PHY device in the node converts the downstream data sent by the core from digital-to-analog to be transmitted on radio frequency as a QAM signal and converts the upstream RF data sent by cable modems from analog-to-digital format to be transmitted optically to the core. Other modern systems push other elements and functions traditionally located in a head end into the network, such as MAC layer functionality(R-MACPHY), etc.

Evolution of CATV architectures, along with the DOCSIS standard, have typically been driven by increasing consumer demand for bandwidth, and more particularly growing demand for Internet and other data services. However, bandwidth is not the only consideration, as many applications such as video teleconferencing, gaming, etc. also require low latency. Thus, the DOCSIS 3.1 specifications incorporated the Low Latency DOCSIS (LLD) feature to enable lower latency and jitter values for latency-sensitive applications by creating two separate service flows, where latency-sensitive traffic is carried over its own service flow that is prioritized over traffic that is not latency-sensitive.

Once traffic is identified as latency sensitive, however, mechanisms must be adopted to reduce the latency for that traffic in a manner that efficiently utilizes bandwidth.

### BRIEF DESCRIPTION OF THE DRAWINGS

For a better understanding of the invention, and to show how the same may be carried into effect, reference will now be made, by way of example, to the accompanying drawings, in which:

FIG. 1A shows an exemplary centralized access architecture (CAA) that may be used to implement the systems and methods disclosed in the present application.

FIG. 1B shows an exemplary distributed access architecture (DAA) that may be used to implement the systems and methods disclosed in the present application

FIG. 2 shows a traditional Request-Grant cycle by which a cable modem send s packets of data in an upstream direction.

FIG. 3 shows an adaptive grant system according to embodiment of the present disclosure.

FIG. 4 shows a method according to embodiments of the present disclosure..

### DETAILED DESCRIPTION

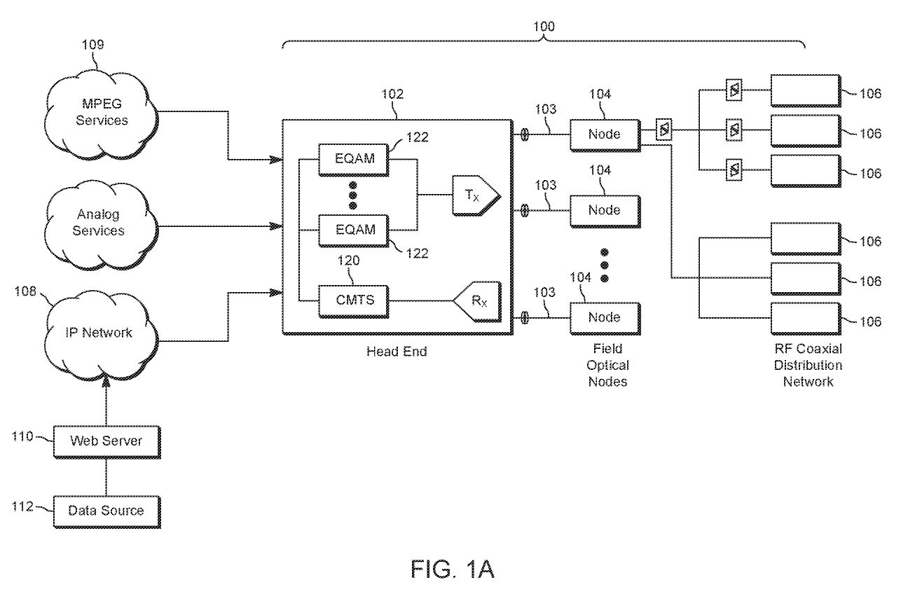

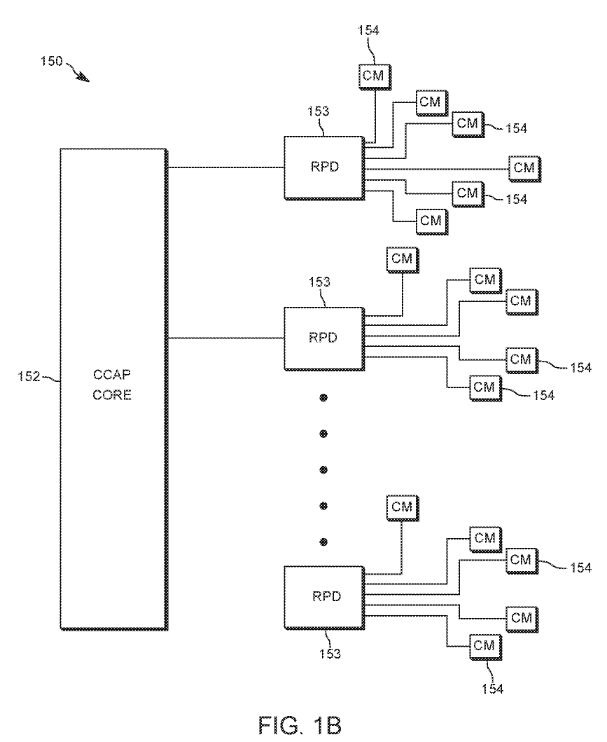

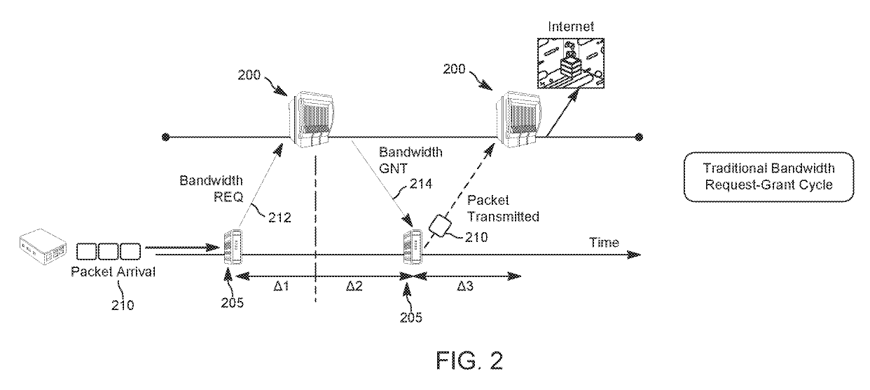

The devices, systems, and methods disclosed in the present application may be implemented with respect to a communications network that provides data services to consumers, regardless of whether the communications network is implemented as a CAA architecture or a DAA architecture, shown respectively in FIGS. 1 and 2.

Referring first to FIG. 1, a Hybrid Fiber Coaxial (HFC) broadband network 100 combines the use of optical fiber and coaxial connections. The network includes a head end 102 that receives analog or digital video signals and digital bit streams representing different services (e.g., video, voice, and Internet) from various digital information sources. For example, the head end 102 may receive content from one or more video on demand (VOD) servers, IPTV broadcast video servers, Internet video sources, or other suitable sources for providing IP content.

An IP network 108 may include a web server 110 and a data source 112. The web server 110 is a streaming server that uses the IP protocol to deliver video-on-demand, audio-on-demand, and pay-per view streams to the IP network 108. The IP data source 112 may be connected to a regional area or backbone network (not shown) that transmits IP content. For example, the regional area network can be or include the Internet or an IP-based network, a computer network, a web-based network or other suitable wired or wireless network or network system.

At the head end 102, the various services are encoded, modulated and upconverted onto RF carriers, combined onto a single electrical signal and inserted into a broadband optical transmitter. A fiber optic network extends from the cable operator’s master/regional head end 102 to a plurality of fiber optic nodes 104. The head end 102 may contain an optical transmitter or transceiver to provide optical communications through optical fibers 103. Regional head ends and/or neighborhood hub sites may also exist between the head end and one or more nodes. The fiber optic portion of the example HFC network 100 extends from the head end 102 to the regional head end/hub and/or to a plurality of nodes 104. The optical transmitter converts the electrical signal to a downstream optically modulated signal that is sent to the nodes. In turn, the optical nodes convert inbound signals to RF energy and return RF signals to optical signals along a return path. In the specification, the drawings, and the claims, the terms “forward path” and “downstream” may be interchangeably used to refer to a path from a head end to a node, a node to a subscriber, or a head end to a subscriber. Conversely, the terms “return path”, “reverse path” and “upstream” may be interchangeably used to refer to a path from a subscriber to a node, a node to a head end, or a subscriber to a head end.

Each node 104 serves a service group comprising one or more customer locations. By way of example, a single node 104 may be connected to thousands of cable modems or other subscriber devices 106. In an example, a fiber node may serve between one and two thousand or more customer locations. In an HFC network, the fiber optic node 104 may be connected to a plurality of subscriber devices 106 via coaxial cable cascade 111, though those of ordinary skill in the art will appreciate that the coaxial cascade may comprise a combination of fiber optic cable and coaxial cable. In some implementations, each node 104 may include a broadband optical receiver to convert the downstream optically modulated signal received from the head end or a hub to an electrical signal provided to the subscribers’ devices 106 through the coaxial cascade 111. Signals may pass from the node 104 to the subscriber devices 106 via the RF cascade 111, which may be comprised of multiple amplifiers and active or passive devices including cabling, taps, splitters, and in-line equalizers. It should be understood that the amplifiers in the RF cascade 111 may be bidirectional, and may be cascaded such that an amplifier may not only feed an amplifier further along in the cascade but may also feed a large number of subscribers. The tap is the customer’s drop interface to the coaxial system. Taps are designed in various values to allow amplitude consistency along the distribution system.

The subscriber devices 106 may reside at a customer location, such as a home of a cable subscriber, and are connected to the cable modem termination system (CMTS) 120 or comparable component located in a head end. A client device 106 may be a modem, e.g., cable modem, MTA (media terminal adaptor), set top box, terminal device, television equipped with set top box, Data Over Cable Service Interface Specification (DOCSIS) terminal device, customer premises equipment (CPE), router, or similar electronic client, end, or terminal devices of subscribers. For example, cable modems and IP set top boxes may support data connection to the Internet and other computer networks via the cable network, and the cable network provides bi-directional communication systems in which data can be sent downstream from the head end to a subscriber and upstream from a subscriber to the head end.

References are made in the present disclosure to a Cable Modem Termination System (CMTS) in the head end 102. In general, the CMTS is a component located at the head end or hub site of the network that exchanges signals between the head end and client devices within the cable network infrastructure. In an example DOCSIS arrangement, for example, the CMTS and the cable modem may be the endpoints of the DOCSIS protocol, with the hybrid fiber coax (HFC) cable plant transmitting information between these endpoints. It will be appreciated that architecture 100 includes one CMTS for illustrative purposes only, as it is in fact customary that multiple CMTSs and their Cable Modems are managed through the management network.

The CMTS 120 hosts downstream and upstream ports and contains numerous receivers, each receiver handling communications between hundreds of end user network elements connected to the broadband network. For example, each CMTS 120 may be connected to several modems of many subscribers, e.g., a single CMTS may be connected to hundreds of modems that vary widely in communication characteristics. In many instances several nodes, such as fiber optic nodes 104, may serve a particular area of a town or city. DOCSIS enables IP packets to pass between devices on either side of the link between the CMTS and the cable modem.

It should be understood that the CMTS is a non-limiting example of a component in the cable network that may be used to exchange signals between the head end and subscriber devices 106 within the cable network infrastructure. For example, other non-limiting examples include a Modular CMTS (M-CMTSTM) architecture or a Converged Cable Access Platform (CCAP).

An EdgeQAM (EQAM) 122 or EQAM modulator may be in the head end or hub device for receiving packets of digital content, such as video or data, repacketizing the digital content into an MPEG transport stream, and digitally modulating the digital transport stream onto a downstream RF carrier using Quadrature Amplitude Modulation (QAM). EdgeQAMs may be used for both digital broadcast, and DOCSIS downstream transmission. In CMTS or M-CMTS implementations, data and video QAMs may be implemented on separately managed and controlled platforms. In CCAP implementations, the CMTS and edge QAM functionality may be combined in one hardware solution, thereby combining data and video delivery.

Referring now to FIG. 2, an exemplary DAA architecture is disclosed, e.g., a R-PHY architecture, although as noted above, other DAA architectures may include R-MACPHY architectures, R-OLT architectures, etc. Specifically, a distributed CATV transmission architecture 150 may include a CCAP 152 at a head end connected to a plurality of cable modems 154 via a branched transmission network that includes a plurality of RPD nodes 153. The RPD nodes 153 perform the physical layer processing by receiving downstream, typically digital content via a plurality of northbound ethernet ports and converting the downstream to QAM modulated signals where necessary, and propagating the content as RF signals on respective southbound ports of a coaxial network to the cable modems. In the upstream direction, the RPD nodes receive upstream data content via the southbound RF coaxial ports, convert the signals to an optical domain, and transmit the optical data upstream to the CCAP 152. The architecture of FIG. 1 is shown as an R-PHY system where the CMTS operates as the CCAP core while Remote Physical Devices (RPDs) are located downstream, but alternate systems may use a traditional CCAP operating fully in an Integrated CMTS in a head end, connected to the cable modems 1544 via a plurality of nodes/amplifiers.

The techniques disclosed herein may be applied to systems compliant with DOCSIS. The cable industry developed the international Data Over Cable System Interface Specification (DOCSIS®) standard or protocol to enable the delivery of IP data packets over cable systems. In general, DOCSIS defines the communications and operations support interface requirements for a data over cable system. For example, DOCIS defines the interface requirements for cable modems involved in high-speed data distribution over cable television system networks. However, it should be understood that the techniques disclosed herein may apply to any system for digital services transmission, such as digital video or Ethernet PON over Coax (EPoc). Examples herein referring to DOCSIS are illustrative and representative of the application of the techniques to a broad range of services carried over coax

As noted earlier, although CATV architectures have historically evolved in response to increasing consumer demand for bandwidth, in the era of high-speed broadband services, a new class of applications not only demand high bandwidth but also low latency in their network path. Many applications such as multiplayer gaming, stock market trading, or Virtual Reality and Augmented Reality, and Video conferencing applications require the power of high bandwidth and low latency to make them work seamlessly. The present disclosure presents solutions to the problem of high latency experienced by these latency sensitive applications in the DOCSIS access network path.

One main sources of latency in the DOCSIS networks is the delay due to the request-grant cycle. Specifically, the DOCSIS network has an upstream spectrum for cable modems to send data and a downstream spectrum for cable modems to receive data. Thus, cable modems communicate with other networked devices such as gaming servers, video conferencing servers, etc. with a virtual connection called a Service Flow (SF) that has two types - Upstream SF and Downstream SF, where the upstream SF schedules traffic based on a method such as Best Effort.

The upstream spectrum is a multi-user shared resource with a Time Division Multiplexing solution. FIG. 2, for example, shows a CMTS 200 in communications with a cable modem 205. When the cable modem has data 210 to be uploaded, a bandwidth request message 212 originates from the cable modem 205 and is send to the CMTS 200, which in turn processes the request and allocate requested bandwidth in form of time slots (called minislots) for upstream transmission. This allocation of bandwidth in minislots is called a bandwidth grant, and it is transmitted in a response message 214, e.g., in a downstream MAC management packet called a MAP message. When the cable modem 205 receives this bandwidth grant message 214, the cable modem 205 processes it and transmits packets 210 at the time intervals provided by the minislots. The scheduling method of the grants to cable modem 205 depends on the DOCSIS scheduling type such as Best Effort, or Unsolicited Grant Service, etc. This technique of transmitting a bandwidth request in the upstream and a bandwidth grant in the downstream is called the bandwidth request-grant cycle. The CMTS 200 also provides a contention minislot in which different cable modems can compete for a given bandwidth minislot.

For low latency service, the delay due to the request-grant cycle is preferably reduced. One proposed standard to do this, called Proactive Grant Service, is specified in the DOCSIS MAC and Upper Layer Protocols Interface (MULPI) specification. In Proactive Grant Service, grants are sent at a Guaranteed Grant Rate at a Guaranteed Grant Interval. For example, the bandwidth grant rate can be 2 Mbps with a grant guaranteed to be transmitted per millisecond. Thus, the incoming traffic in the upstream that requires those bandwidth grants can be 100 kbps but the granting will assume that 2 Mbps is required and continue granting at that rate and the same interval. This results in wasting of 1.9 Mbps of grants and wasted CPU cycles to ensure that the grant interval is 1 millisecond.

The present specification discloses a novel improved technique, referred to as an “Adaptive Grant Service,” and is a real-time scheduling technique that optimizes the number of grants given so as to service the dynamically changing upstream bandwidth needs, and maintain the latency of a latency sensitive application. The benefits of this approach are to optimize bandwidth grant minislots, reduce the upstream latency, and save computing resources in under-utilized service flow. Proactive Grant Service differs from the standard bandwidth grant-request cycle by proactively granting minislots for upstream packet transmissions without a specific, preceding request by a cable modem. Stated broadly, the disclosed systems and methods that implement the Adaptive Grant Service as described herein improve upon Proactive Grant Service by dynamically modulating the size of the proactive upstream grants to adapt to changes in the size of actual upstream transmissions by a cable modem. Stated differently, the disclosed systems and method use prior measurements of actual upstream bursts of a cable modem to predictively adjust the size of packets proactively granted by the CMTS.

Generally speaking, Internet traffic rarely follows a constant bit-rate type of transmission; instead, traffic is generally transmitted in bursts. A burst can be characterized by burst height, burst duration, and a burst interval. The adaption of the proactive grants according to the disclosed systems and methods can be based on different functions, depending on the incoming traffic pattern burst height, burst duration, and burst interval. The number of granted bytes, duration of those granted bytes, and the interval between those granted bytes are calculated by the adaptive grant algorithm within a moving window of time.

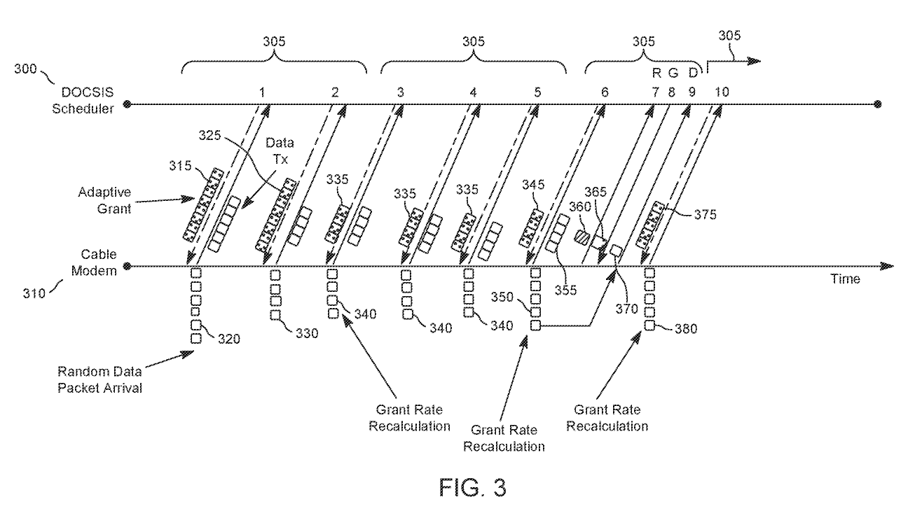

FIG. 3 broadly illustrates the disclosed Adaptive Grant Service. Upon initiation of a latency sensitive application, assume that a DOCSIS scheduler 300 in a CMTS proactively grants a cable modem 310 an upstream transmission adaptive grant 315 for a burst size of eight bytes of packets at time 1 (e.g., a minislot). The DOCSIS scheduler 300 is also configured to adapt the size of the adaptive grant following each successive recalculation interval 305. In the specification and claims, an “adaptive grant” is a grant of upstream bandwidth that has the characteristics of being granted without a prior request by a cable modem, and where the amount of bandwidth granted over an interval is adjustable or adaptive. The cable modem, however, has only six bytes of packets 320 to transmit in an upstream burst, and transmits them. Because the first recalculation interval 305 is still in progress, however, the DOCSIS scheduler at time 2 continues to proactively grant an upstream transmission adaptive grant 325 for a burst size of eight bytes of packets. At this point in time, the cable modem 310 only has four bytes of packets 330 to transmit in an upstream burst, and does so. At time 3, however, the first recalculation interval 305 has been completed, and the DOCSIS scheduler 300 determines that more adaptive grant bytes have been granted than used by the cable modem, so it adaptively reduces or throttles the adaptive grants to four bytes of packets 335. As stated earlier, the present disclosure contemplates a wide variety of specific formulas or algorithms by which the DOCSIS scheduler adapts the proactive grants to past upstream transmissions by the cable modems. For example, some systems or methods may proactively grant bytes of upstream transmissions equal to the size of the last upstream burst, or alternatively to the average size of upstream bursts over the preceding calculation interval, or may still alternatively reduce it by one of a plurality of predefined scaling factors selected based on the size of preceding upstream bursts, etc.

In the example of FIG. 3., as just stated, the DOSCIC scheduler 300 adaptively reduced the proactive grant 335 during the second recalculation interval to four bytes of packets, and the cable modem had four bytes of packets 340 to transmit in an upstream burst for an efficiency of 100%, and this pattern continues through the remainder of the second grant interval 305 through times 4 and 5. Therefore, at time 6, the DOCSIS scheduler 300, seeing 100% efficiency in the prior grant interval, again issues a proactive grant 345 of four bytes of packets. The cable modem 310, however, has five bytes of packet data 350 to transmit in the upstream direction. The cable modem then uses the proactive grant to transmit 4 bytes of packets 355 in the upstream direction, but then makes a request 360 to send another byte of packet data to the DOCSIS scheduler 300 at time 7. Upon receipt of that request, the DOCSIS scheduler provides an additional grant 365 for a byte of packet data at time 8 and at time 9 the cable modem 310 sends the packet 370 in the upstream direction.

In the fourth recalculation period, the DOCSIS scheduler 300 recognizes that in the preceding recalculation interval, more total bytes were sent by the cable modem 310 than adaptive grant bytes given i.e., the cable modem 310 had to specifically request a grant of additional bytes of packets. The DOCSIS scheduler therefore increases the amount of adaptive grant bytes using a scaling factor - in the example of FIG. 3 thereby increasing the proactive adaptive grant bytes to a grant 375 of five adaptive grant bytes of packets. In this example, the cable modem 320 has five bytes of packets 380 to transmit in the upstream direction, and does not need to again request a further upstream grant.

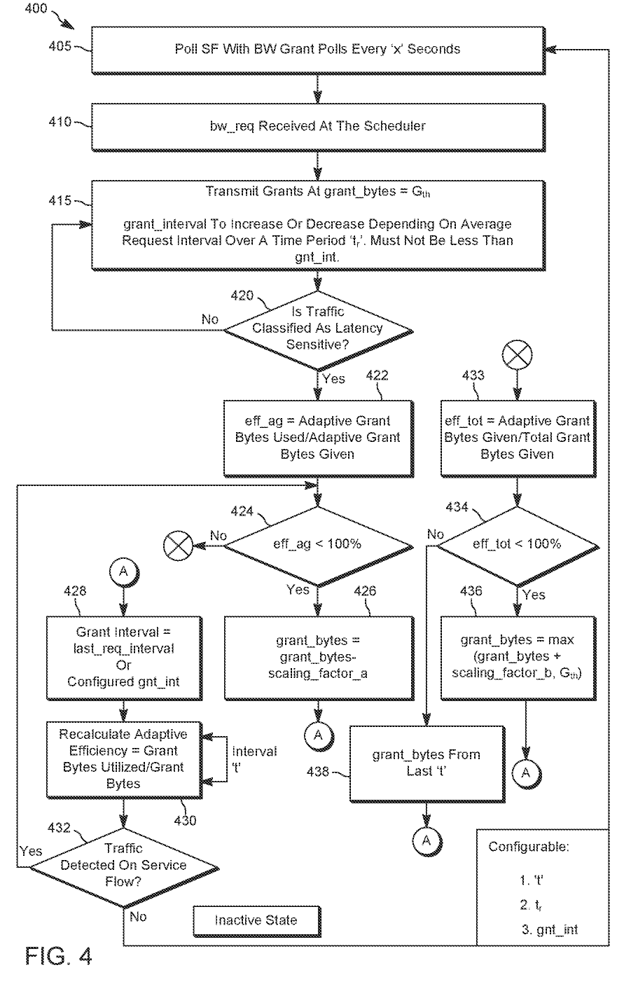

FIG. 4 illustrates an exemplary method 400 that may be used to effectuate the systems previously described. In step 405, a DOCIS scheduler or similar apparatus may poll a service flow to determine whether any bandwidth grants are requested, at a configurable interval of “x” seconds. Once a bandwidth request is received at the scheduler efficiency engine, it calculates the bandwidth bytes being requested i.e., the burst height and the interval of bursts in an interval. This calculation is always in a running state. When a request is received at step 410, the method proceeds to transmit grants at a rate of Gₜₕ, which is the maximum granting threshold in bits per second, and is bounded by the maximum sustained traffic rate of the service flow or the advertised billboard bandwidth of the subscriber. At step 415, grant bytes are granted at the rate Gₜₕ over a variable interval tᵣ calculated based on the average interval between requests received at step 410, subject to a configurable floor gnt_int that the variable interval cannot be less than.

At step 420, the method determines whether the traffic is classified as latency sensitive; if not the method returns to step 415 to grant more bytes in the ongoing service flow. If traffic for a service flow is classified as latency sensitive, however, the method proceeds to step 422 where adaptive grant bytes are provided, upstream bytes are received, and additional (non-adaptive) grant bytes are requested and received as described with respect to FIG. 3, over another configurable interval t, and where during this interval an average efficiency eff_ag is calculated which measures the ratio of adaptive grants used to adaptive grant bytes given over an applicable interval t. At step 424 the method determines whether eff_ag is less than 100%. If it is, then grant bytes are reduced by a scaling adjustment “a” and the method proceeds to step 428 where the grant interval is selectively adjusted to the interval between the most recent preceding requests, subject to the floor as described above, and at step 430 the eff_av is calculated over this selectively modified grant interval as adaptive grants are provided, used, etc. At step 432 the method determines whether additional traffic is detected on the service flow. If the answer is no, the method reverts to step 405 where the adaptive algorithm will enter an inactive state and scheduler will transmit unicast polling grants every ‘x’ seconds. Conversely, if the service flow is ongoing, the method reverts to step 424 where a new eff_av is calculated, and so forth.

At step 424, whenever eff_av is not less than 100%, the method then proceeds to step 433 where a total efficiency eff tot is calculated, which measures the adaptive grant bytes given divided by the total grant bytes given. At step 434 it is determined whether this eff tot metric is less than 100%. If the answer is “no” (which means that it must equal 100%, given decision step 424) then the at step 438 the grant bytes used from the last interval “t” are used again, and the procedure proceeds to step 428. If the answer is “yes” then the method proceeds to step 436 where the adaptive grant bytes are recalculated to be the larger of the prior adaptive grant bytes adjusted by a positive scaling adjustment “b” (thus increasing the adaptive grant bytes), or the maximum grant bytes Gₜₕ. Then the process proceeds to step 428.

As indicated previously, different scaling algorithms can be used for scaling adjustments “a” and “b.” These algorithms can, for example, be percentage step, a step function, a linear ramp function or any other desired function.

1. An apparatus comprising a scheduler that proactively allocates grants for transmission bursts in an upstream direction by a remote device, the upstream bursts limited by a grant of a variable size, the size of the grant adaptively varied by the apparatus based on a measurement of prior usage of adaptive grants by the remote device.

2. The apparatus of claim 1 where the adaptive grants are varied based on a measurement of prior efficiency of usage of adaptive grants by the remote device.

3. The apparatus of claim 2 where the adaptive grants are decreased when the remote device does not use all of the adaptive grant bytes previously granted.

4. The apparatus of claim 2 where the adaptive grants are adjusted using at least one scaling factor.

5. The apparatus of claim 2 where the measurement of prior efficiency of usage is measured over an interval.

6. The apparatus of claim 5 where the interval is automatically adjusted by the apparatus.

7. The apparatus of claim 6 where the interval is subject to a minimum interval.

8. The apparatus of claim 1 comprising a DOCSIS scheduler.

9. The apparatus of claim 8 where the remote device is a cable modem.

10. The apparatus of claim 1 where the adaptive grants are varied based on a determination that the remote device is transmitting latency sensitive traffic in the upstream direction.

11. A method implemented in a network apparatus for scheduling upstream transmissions from a remote device, the method comprising:
proactively granting the remote device an amount of bandwidth for the upstream transmissions over an interval;
measuring a metric of usage of the amount of bandwidth by the remote device over the interval; and
adjusting the amount of bandwidth proactively granted over a next sequential interval based on the measured metric.

12. The method of claim 11 where the metric is an efficiency of usage of the adaptive grants by the remote device over the interval.

13. The method of claim 12 where the amount of bandwidth is decreased when the remote device does not use all of the adaptive grant bytes previously granted.

14. The method of claim 13 where the amount of bandwidth is adjusted using at least one scaling factor.

15. The method of claim 11 where the interval is automatically adjusted by the apparatus.

16. The method of claim 15 where the interval is subject to a minimum interval.

17. The method of claim 11 where amount of bandwidth is increased when the remote device uses more bandwidth than is proactively granted.

18. The method of claim 11 implemented in DOCSIS scheduler.

19. The method of claim 18 where the remote device is a cable modem.

20. The method of claim 11 where the adaptive grants are varied based on a determination that the remote device is transmitting latency sensitive traffic in the upstream direction.
